(19) United States
(12) Patent Application Publication
(10) Pub. No.: US 2026/0307246 A1
(43) Pub. Date: Oct. 8, 2026

(54) System and Method for Controlling Wheeled Mobile Manipulators

(71) Applicant: Mitsubishi Electric Research Laboratories, Inc., Cambridge, MA (US)

(72) Inventors: Yebin Wang, Cambridge, MA (US); Min Dai, Pasadena, CA (US)

(73) Assignee: Mitsubishi Electric Research Laboratories, Inc., Cambridge, MA (US)

(21) Appl. No.: 19/095,337

(22) Filed: Mar. 31, 2025

(51) Int. Cl. B25J 9/16; B25J 5/00

(52) U.S. Cl. CPC B25J 9/1633; B25J 5/007; B25J 9/1664

(57) ABSTRACT

A method for controlling a robot include receiving a task in the form of a sequence of waypoints at which robot is collision-free, and determining a safe trajectory of a coordinated motion of a wheeled base and a manipulator arm of the robot to perform the task using a joint motion model including external forces acting on the robot moving according to the trajectory while ignoring dynamics of internal forces generated by actuators of the robot that cause the external forces. The safe trajectory is determined subject to stability constraints on the external forces. The method further includes determining the internal forces for actuators of the robot to track the safe trajectory subject to feasibility constraints such that the safe trajectory is adjusted to satisfy the feasibility constraints to produce a feasible trajectory. Moreover, the method includes controlling the actuators of the robot to follow the feasible trajectory.

### TECHNICAL FIELD

The present disclosure generally relates to robotics and associated motion planning. More specifically, the present disclosure relates to methods for controlling mobile manipulators having a wheeled base and an articulated manipulator.

### BACKGROUND

Mobile manipulators are widely used in manufacturing, logistics, medical robotics, and service industries due to extended reach of associated manipulator arms while allowing repositioning within a workspace. Unlike fixed-base manipulators, mobile manipulators coordinate the movement of both wheeled base and manipulator arm to perform tasks such as object manipulation, assembly, inspection, and material transport. However, achieving simultaneous control of mobility and dexterity introduces significant technical challenges, particularly in ensuring stability, safety, and efficient task execution.

One of the primary challenges in mobile manipulators is fast motion planning under stability constraints. When the manipulator moves or extends, the center of mass (COM) shifts that can lead to tip-over. Many existing approaches, to achieve fast planning, rely on sequential planning, where the base moves first and then the manipulator operates. However, in order to prevent or manage tip over, such methods result in slow execution of task and are inefficient for real-time applications. More advanced approaches attempt to synchronize the movement of the base and manipulator, but such approaches generally impose overly conservative velocity limits to prevent tipping, thereby reducing overall performance.

Another significant limitation of conventional systems is the reliance on either kinematic models or full-body dynamic models for motion planning. Kinematic models are computationally efficient but fail to capture 1) the dynamic interactions between the base and manipulator and 2) the dynamic interactions between the base and the ground, making them unreliable for high-speed motion due to generation of unsafe maneuvers. Full dynamic models, on the other hand, account for force interactions but are computationally expensive and difficult to implement in real-time robotic control. Additionally, many existing methods rely on reactive tip-over prevention mechanisms that adjust the robot's movement only after instability is detected, leading to inefficient and sometimes unpredictable corrections.

Furthermore, current methods often fail to differentiate between forces that impact stability and forces that impact motion feasibility. A mobile manipulator needs to consider external forces such as ground reaction forces, gravitational forces, and inertial forces to ensure stability, while internal forces generated by actuators determine whether a planned trajectory is physically executable. Many existing planning algorithms either overcompensate for stability, leading to unnecessarily restrictive motion constraints, or fail to consider actuation feasibility, resulting in motion plans that exceed actuator torque limits.

Given these challenges, there is a need for an improved motion planning and control method for mobile manipulators that ensures stability and feasibility while maintaining computational efficiency.

### SUMMARY

The disclosure provides an improved motion planning and control method for mobile manipulators that ensures stability and feasibility while maintaining computational efficiency. The disclosure provides a method that effectively integrates stability constraints into motion planning, differentiates external and internal forces, and allows for real-time trajectory adjustment would significantly enhance the agility, safety, and operational efficiency of mobile manipulators.

The method plans the motion of the mobile manipulators and controls the mobile manipulator by determining a safe trajectory of a coordinated motion of the base and the arm using a joint motion model that considers external forces during motion while ignoring dynamics of internal forces acting on the robot and applying stability constraints on the external forces for determining the safe trajectory ensuring that external forces maintain dynamic stability of the robot during motion. In embodiments, the stability constraints are applied/enforced by applying Zero Moment Point (ZMP) constraints to ensure that the resultant external forces and moments acting on the robot maintain the robot's ZMP within a support polygon. Also, the joint motion model is a reduced order model having a centroidal momentum model that represents the dynamics of the net linear and angular momentum of the robot's center of mass, thereby enabling the determination of external forces result from a motion while ignoring joint-level internal forces.

Another embodiment discloses a method for controlling a robot for performing a task. The robot is a mobile manipulator including a nonholonomic base having wheels for moving on flat surfaces and a manipulator arm connected to the wheeled base and having additional degrees of freedom for performing the task. The method uses a processor coupled with stored instructions implementing the method. The instructions, when executed by the processor carry out steps of the method including receiving a task in the form of a sequence of waypoints from a task planner. The robot at the sequence of waypoints is collision-free. The method also includes determining a safe trajectory of a coordinated motion of the wheeled base and the manipulator arm of the robot to perform the task using a joint motion model of the wheeled base and the manipulator arm of the robot including external forces acting on the robot moving according to the trajectory while ignoring dynamics of internal forces generated by actuators of the robot that cause the external forces. The safe trajectory is determined subject to stability constraints on the external forces ensuring that external forces maintain dynamic stability of the robot. The method further includes determining the internal forces for actuators of the robot to track the safe trajectory subject to feasibility constraints on the generation of the internal forces by the actuators, such that the safe trajectory is adjusted to satisfy the feasibility constraints to produce feasible trajectory. Moreover, the method includes controlling the actuators of the robot to generate the internal forces causing the robot to follow the feasible trajectory.

### BRIEF DESCRIPTION OF THE DRAWINGS

FIG. 1 shows a schematic of transitioning from a prior art sequential approach of generating motion trajectory to directly integrating the motion planning and stability constraints to achieve efficient and feasible trajectory according to some embodiments.

FIG. 2 shows a schematic of transitioning a unified dynamic model that integrates both internal and external forces to generate motion trajectory to a motion planning model constructed based only on external forces to generate a safe trajectory according to some embodiments,

FIG. 3 shows a robot having a wheeled base and a manipulator arm according to an example embodiment.

FIG. 4 shows a block diagram schematically depicting various elements of a controller for controlling the robot, according to some embodiments.

FIG. 5A shows a block diagram schematically depicting various elements of a safe motion planner to generate a safe trajectory for the movement of the robot according to some embodiments.

FIG. 5B shows transitioning from modelling wrench for each wheel of a base of the robot to a single virtual lumped wrench determined using wheel ground contact model generated by treating the wheeled base as a rigid body in contact with the ground according to some embodiments.

FIG. 6 shows a block diagram depicting various elements involved in generating a feasible trajectory from a safe trajectory according to some embodiments.

FIG. 7 shows a block diagram depicting various elements involved in generating a feasible trajectory from a safe trajectory according to some embodiments.

FIG. 8 shows a method for controlling the robot to perform a task according to some embodiments.

FIG. 9 shows a method for enforcing the stability constraints on the external forces to generate a safe trajectory according to some embodiments.

FIG. 10 shows a method for determining internal forces for tracking the safe trajectory and adjusting the safe trajectory to the feasible trajectory according to some embodiments.

FIG. 11 shows a method for determining the safe trajectory by using a joint motion model according to some embodiments.

### DETAILED DESCRIPTION

### Overview of the Contribution to the Art

This overview is provided to introduce a selection of concepts in a simplified form that are further described below in the Detailed Description. This Overview is not intended to identify key features or essential features of the claimed subject matter, nor is it intended to be used as an aid in determining the scope of the claimed subject matter.

Embodiments of the disclosure are based on the recognition that motion planning and stability in mobile manipulators are fundamentally interconnected. When the motion planning is approached as an independent problem with stability constraints introduced as a secondary consideration, this approach leads to inefficiencies or lack of safety guarantee. Specifically, when motion trajectories are first generated and then later adjusted or restricted to prevent instability, such as tipping, such post hoc modifications result in unpredictable trajectory alterations, slower task execution, and excessive conservatism. Embodiments recognize that to achieve efficient and dynamically feasible trajectory planning, stability is to be integrated directly into the motion planning process rather than applied as a corrective measure after the fact.

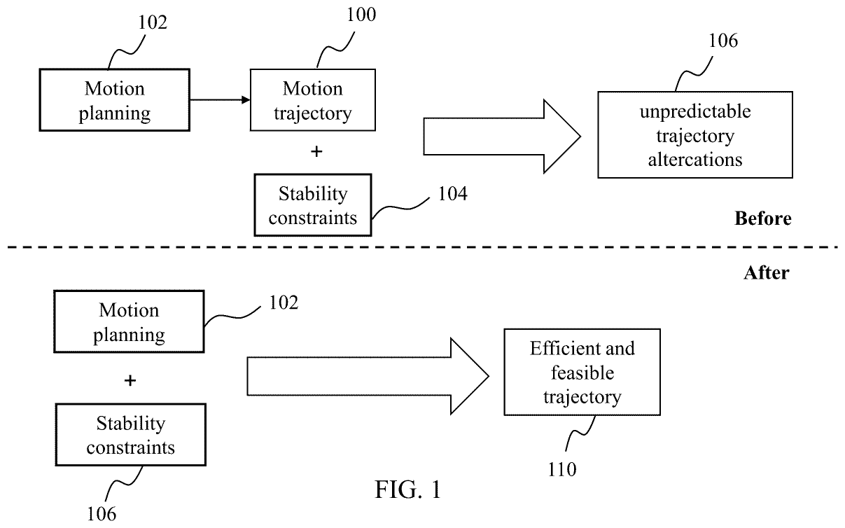

FIG. 1 shows a schematic of transitioning from a prior art sequential approach of generating motion trajectory 100 using motion planning 102 and then adjusting the generated trajectory 100 based on stability constraints 104 that result into unpredictable trajectory altercations to directly integrating the motion planning 102 and stability constraints 106 to achieve efficient and feasible trajectory 110.

Further embodiments are based on the realization that motion feasibility and safety originate from different physical principles. Feasibility is primarily dictated by internal forces—the forces generated by the robot's actuators, such as torques applied by motors to the manipulator joints and base wheels. In contrast, safety, particularly the prevention of tipping, is governed by external forces, such as gravity, ground reaction forces, and inertial effects during movement. Conventional approaches typically consider a unified dynamic model that integrates both internal and external forces, treating them as coupled. However, embodiments recognize that for safety considerations, external forces are dominant over internal forces.

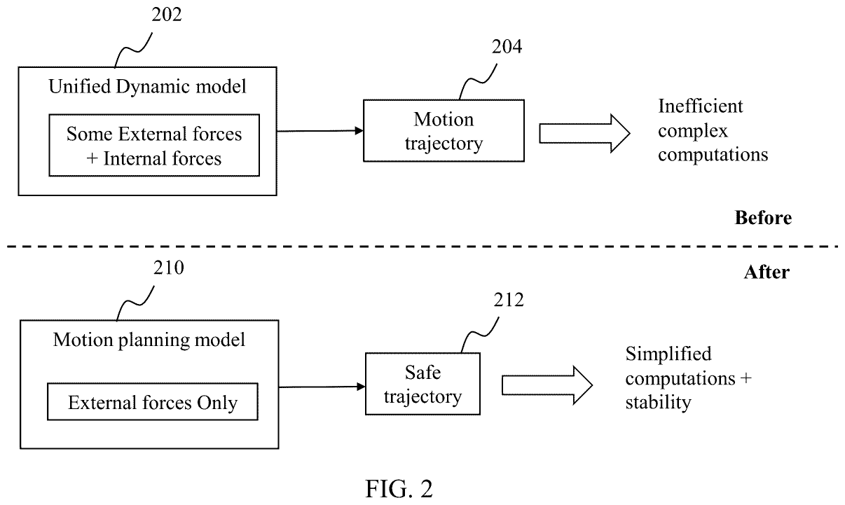

FIG. 2 shows a schematic of transitioning from a unified dynamic model 200 that integrates both internal and a few external forces to generate motion trajectory 202 involving inefficient complex computations to a motion planning model 210 constructed based only on external forces to generate a safe trajectory 212, leading to significantly simplifying computations while still ensuring stability. This distinction enables embodiments to generate the safe trajectory in a more efficient manner than traditional approaches.

Some embodiments address the problem of controlling a robot to perform a task, wherein the robot is a mobile manipulator comprising a nonholonomic base equipped with wheels for movement on flat surfaces and a manipulator connected to the base, providing additional degrees of freedom for executing the task. Examples of such a manipulator include a robotic arm with multiple joints and corresponding degrees of freedom, enabling operations such as picking, inserting, moving objects, and other manipulation tasks.

A robot of this type possesses a high number of degrees of freedom, corresponding to internal forces generated by the robot's actuators to control its movement. However, despite this complexity, all these internal forces collectively result in a much smaller number of external forces acting on the robot's wheels and its interaction with the environment. Since external forces arise as a reaction to internal forces, considering only external forces while ignoring internal forces during motion planning can lead to a significant reduction in the dimensionality of the motion planning problem. This simplification enables more computationally efficient trajectory generation while maintaining stability and control accuracy.

Embodiments further recognize that while prioritizing safety ensures that a trajectory is stable, it does not inherently guarantee feasibility. In other words, a trajectory planned solely based on external forces may, in rare cases, demand internal forces (e.g., motor torques) that exceed the robot's physical actuation capabilities. However, experimental verification has shown that such situations are uncommon. In most cases, a trajectory designed with external force constraints remains feasible for execution. Moreover, even when an initially generated trajectory is infeasible, it remains safe-meaning that it does not induce tipping or instability. This allows for a real-time feasibility correction mechanism that can slightly modify the trajectory at execution time, ensuring that it remains within the robot's actuation limits while preserving its stability. As a result, embodiments recognize that a two-phase approach first generating a safe trajectory based on external forces and then applying real-time feasibility adjustments-leads to a computationally efficient, yet dynamically feasible, motion planning framework.

Another embodiment is based on the realization that internal forces typically dominate external forces in most robots because internal forces cause external reaction forces. For this reason, traditional motion models are written with respect to internal forces, as they are the primary driver of movement. However, for tipping prevention, the predominant concern is external forces, as the robot tips over when the external force interactions (e.g., the ground reaction forces and inertial loads) cause the Zero Moment Point (ZMP) to shift outside of the support polygon. Embodiments recognize that by rewriting the motion model in terms of external forces rather than internal forces, the overall dimensionality of the motion model can be reduced while still capturing the essential dynamics relevant to stability. This transformation simplifies computations while maintaining accuracy in predicting stability constraints.

Building upon this realization, further embodiments recognize that centroidal momentum provides an optimal framework for modeling external forces while ignoring internal forces. Traditional force-based models track individual interactions between joints, actuators, and the environment, leading to high-dimensional computations. In contrast, centroidal momentum dynamics consolidate the effects of external forces by modeling the net linear and angular momentum at the robot's center of mass (COM). This eliminates the need to explicitly consider every internal joint force while still capturing the dynamic effects that impact stability. As a result, centroidal momentum serves as a computationally efficient yet accurate representation of the external forces acting on the system, aligning perfectly with the prior recognition that safety can be determined by external force considerations alone.

In addition, embodiments recognize that stability can be efficiently enforced through ZMP constraints. ZMP is a well-established metric for assessing whether a robot will tip over based on the balance of external forces and moments. However, conventional approaches often compute ZMP reactively or use high-fidelity dynamic models that require extensive computational resources. Embodiments integrate ZMP constraints directly into the motion planning phase, ensuring that the generated trajectory is stable from the outset, rather than requiring post-processing corrections. Additionally, since full ZMP computations can be expensive, embodiments employ reduced-order modeling techniques (such as centroidal momentum-based formulations) to ensure that ZMP constraints are enforced without excessive computational overhead.

Another embodiment is based on the recognition that a trade-off exists between manipulator extension and base velocity when ensuring stability. Since a robot's COM shifts depending on the position of the manipulator, the planned trajectory balances manipulator arm movement with base motion to maintain stability constraints. If the manipulator arm extends too far while the base accelerates/decelerates-, the ZMP may shift outside the support polygon, leading to instability. Embodiments recognize that by dynamically adjusting ZMP constraints based on the planned task, the motion planner can determine the optimal balance between manipulator reach and base movement. This adaptive stability enforcement allows the robot to maximize its task execution capability while maintaining safety.

In view of these recognitions, embodiments provide a novel motion planning framework that integrates safety and feasibility constraints in a computationally efficient manner. By prioritizing external forces for stability (safety) while allowing internal force adjustments to correct feasibility limitations in real time, embodiments achieve a dynamically stable, computationally efficient, and task-effective solution for mobile manipulator motion planning. Furthermore, by leveraging centroidal momentum as a reduced-order model, some embodiments enable real-time execution without excessive computational requirements. The integration of ZMP-based stability constraints, adaptive manipulator-base coordination, and real-time feasibility adjustments results in a robust motion planning method that ensures mobile manipulators can execute tasks safely, efficiently, and without unnecessary conservatism.

This disclosure aims to enable the agile maneuvering of a class of wheeled mobile manipulators while ensuring dynamic feasibility and safety during motion planning, striking a better balance between safety and productivity. This boils down to faithfully capture and effectively exploit the constraints/models related to dynamic feasibility and safety during motion planning and control, specifically, the constraints and models should be simple enough.

Embodiments of the disclosure provide a method and system for controlling a wheeled mobile manipulator where the mobile base is driven by differential drives.

This disclosure is based on the realization that it is crucial to perform motion planning based on a reduced order model which characterizes the kinematic feasibility, dynamic feasibility, and safety. Here kinematic feasibility, arising from the differential drives, is characterized by nonholonomic constraints embedded in the base's kinematic model over the 2D plane, which involves linear translation in x and y directions and rotation in z direction (also named after yaw).

It is further realized that in order to capture and thus avoid unsafe maneuvers, the base should be treated as a floating base with 6 degree-of-freedoms (DoFs), and thus the 6 DoFs kinematic model of the base is considered.

Also, it is important to enforce the ZMP lying inside a convex hull formed by the wheels to prevent unsafe maneuver, e.g., tipping over.

It is another realization of this disclosure that the dynamic feasibility of the motion for a given mobile manipulator is largely governed by the interaction between the ground and wheels-how much force and torque (their combination is named after wrench) that the ground can be exerted on the base through its interaction with wheels. Given the joint position and velocity for a particular mobile manipulator, the centroidal linear and angular momentum of the mobile manipulator are given; and by viewing the mobile manipulator as an isolated system, the force and torque it needs from the ground is fully captured by the rate of changes of the momentum, i.e., the centroidal dynamics of the mobile manipulator. In other words, as long as a motion induces a lumped wrench which can be produced by the wheel and ground interaction, then the motion is dynamically feasible (here the dynamic constraints induced by the actuators are ignored).

In some embodiments, the dynamic feasibility can be represented by constraining the rate of changes of the angular momentum corresponding to a wrench applied on the base (through the wheels) which lies inside certain friction cones.

### DETAILED DESCRIPTION OF FIGURES

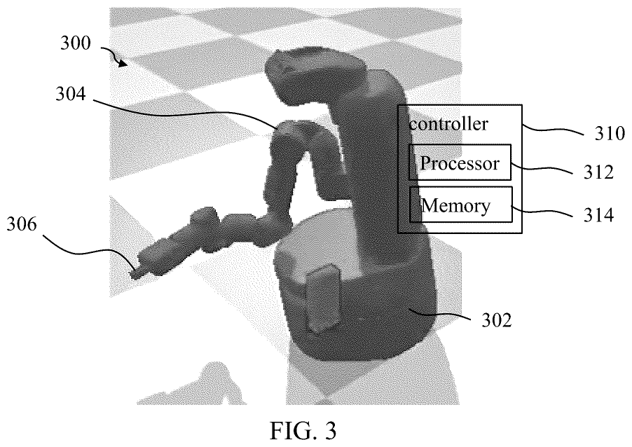

Referring to FIG. 3, an example mobile manipulator robot 300 (hereinafter simply referred to as robot 300) to perform a task, for example, moving an object from one location to another location) is shown. The robot 300 includes a wheeled base 302 and a manipulator arm 304 arranged supported on the wheeled base 302 and configured to move relative to the wheeled base 302. The arm 304 includes an end effector 306, for example, a gripper, to pick objects from on location, hold the object during manipulation of the manipulator arm 304 and movement of the wheeled base 302 from the one location to another location, and positions the object at a desired location. In the embodiment, to manipulate the object, the robot 300 moves over a surface using the wheeled base 302 and simultaneously manipulates the arm 304 to reach the object. For so doing, a controller 310 of the robot 300 control the robot 300 using a method that relies on external forces to generate a trajectory of motion of the robot as described hereinafter. The controller 310 includes a processor 312 to carry out instructions to control the robot 300 to perform a task and a memory 314 to store instructions and models related to the controlling the robot 300.

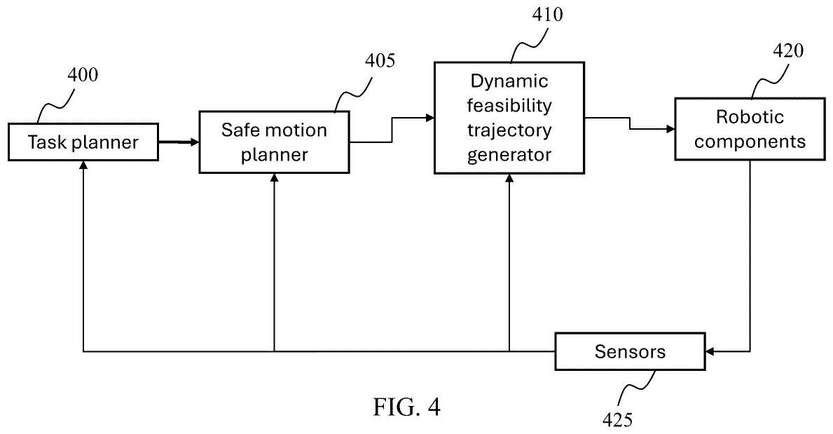

Referring to FIG. 4, a block diagram schematically depicting various steps/elements of the controller 310 in controlling the robot 100 is now described. For controlling the robot 300 and moving the robot 300 from one location to another location to reach an object, a task planner 402 generates a sequence of waypoints to reach an object and perform a task, for example, picking the object. It may be noted that the task planner 402 generates the sequence waypoints such that the movement/motion of the robot is free from collision with environment and itself. The task planner 402 shares the generated sequence of way points with a safe motion planner 405, and the motion planner 405 generates a safe trajectory of a coordinated motion of the wheeled base 302 and the manipulator arm 304 of the robot 300 to perform the task based on the sequence of waypoints. In the embodiments, the motion planner 405 uses a joint motion model of the wheeled base 302 and the manipulator arm 304 to generate the safe trajectory.

In some embodiments, the waypoints are represented as a pose of the end-effector or configurations of all DoFs of the mobile manipulator, wherein the configuration comprises the angles of wheels, linear and angular displacements of the base, and the displacements along all DoFs of the arm.

In the embodiments, the joint motion model considers/includes the external forces acting on the robot moving according to the trajectory while ignoring dynamics of internal forces generated by actuators of the robot 300 that cause the external forces. Also, the motion planner 405 determines the safe trajectory by applying stability constraints on the external forces ensuring that external forces maintain dynamic stability of the robot. The stability constraints prevent any instability, for example, tip over, of the robot 300 during the motion of the robot 300. It may be noted that by using/applying the stability constraints on the external forces, the motion planner 405 determines an optimal balance between the movements of manipulator arm 304 and wheeled base 302. This adaptive stability enforcement allows the robot to maximize the task execution capability while maintaining safety.

Upon generating the safe trajectory, a feasible trajectory generator and tracking controller 410 checks the safe trajectory received from the motion planner 405 and adjusts the saft trajectory to generate a feasible trajectory such that the feasible trajectory satisfies the feasibility constraints when infeasibility of tracking/following the safe trajectory is detected. For adjusting the safe trajectory, the feasible trajectory generator and tracking controller 410 determines the internal forces to be generated by the actuators of the robot 300 to follow the safe trajectory and meet the feasibility constraints. In embodiments, the feasibility constraints include internal forces limit of the actuators that can be generated by the actuators. Upon generating the feasibility trajectory, the robot components 420, for example, the actuators, are controlled to generate the internal forces causing the robot to follow the safe trajectory or the adjusted safe trajectory i.e., feasible trajectory. While moving the robot 300 according to the feasible trajectory, sensors 425 of the robot 100 detects the trajectory followed by the robot, internal forces of the actuators, the external forces on the robot and share the feedback to the motion planner 405, the task planner 402, the trajectory generator and controller 410 to allow safe manipulation of the robot 300.

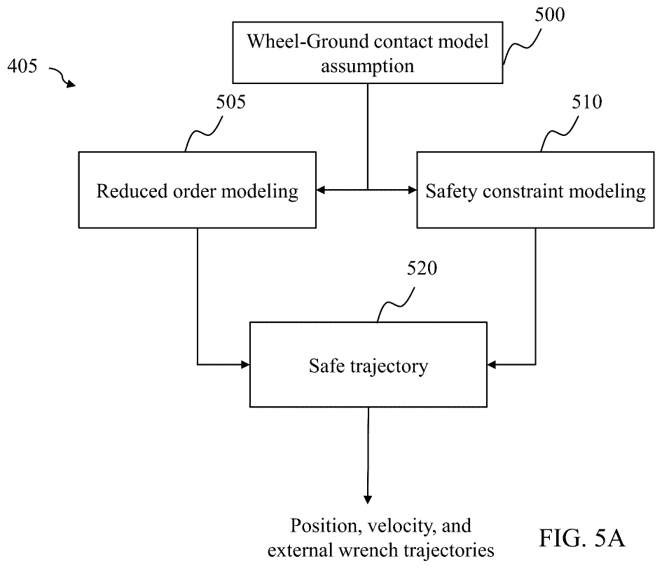

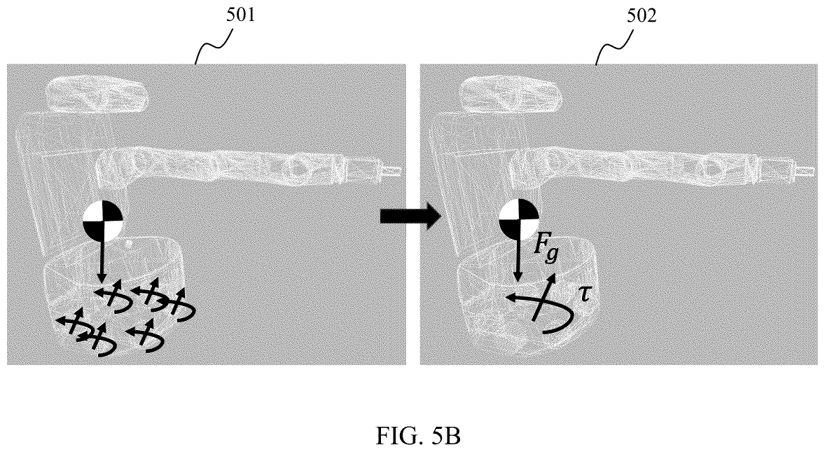

Referring to FIG. 5A, a block diagram depicting various elements of the safe motion planner 405 is shown. The motion planner 405 includes wheel ground contact model 500 to generate a reduced order model 505 and safe constraint model 510. Generally, the robot 300 experiences contact wrenches at all wheels that are in contact with the ground, where each wrench is a 6-dimension vector. The wheel-ground contact wrench, which encompasses normal forces, frictional forces and moments, and the resulting slip dynamics, depends on factors such as slip angle, tire properties, surface material, and contact mechanics. Modeling individual contact wrenches at each wheel introduces considerable computational complexity and is unnecessary to derive a wheel-ground contact model of the mobile manipulator which captures the wrenches of all wheels and perform motion planning based on the model.

Accordingly, the present disclosure determines the wheel ground contact model 500 by treating the wheeled base as a rigid body in contact with the ground. As the safe motion planner 405 focuses on tip-over prevention which is achieved by ensuring that the ZMP remains within the support polygon on the ground. As a result, the wheel ground contact model 500 simply treats the wrenches exerted on all wheels as a single virtual lumped wrench 502 given by

$$f = {[ \begin{matrix}{F}_{x} & {F}_{y} & {F}_{z} & {M}_{x} & {M}_{y} & {M}_{z}\end{matrix} ]}^{T} .$$

where Fₓ, F_{y}, F_{z} are the forces (that the ground applies on the rigid body) along the x, y, z axes, respectively, and Mₓ, M_{y}, M_{z} are the torques around the x, y, z axes, respectively, as shown in FIG. 5B relative to the wrench 501 for each wheel separately. This simplification allows the further reduction from full dynamics to centroidal momentum dynamics which is subject to the virtual lumped wrench, and provides a balance that preserves safety aspects while significantly reducing computational demands.

This single virtual lumped wrench 502 is used to by the motion planner 405 to modelling the reduced order model 505 or the join motion model 505 to determine the safe trajectory 520 of the movement of the robot 300 as per the received waypoints. The safe trajectory 520 includes position, velocity and wrench trajectories of the wheeled base and manipulator arm.

### Kinematic Model

The kinematic model for a differential drive robot is based on a coordinate system where the base frame is centered at the robot's center of rotation. In some embodiments, the position and orientation of the mobile base on flat ground are given by generalized coordinates q_{b,3}=[x_{b} y_{b} θ_{b}]^{T}, where x_{b} and y_{b} are the Cartesian coordinates, and θ_{b} is the heading angle. This simplified 3D coordinate representation is often used in the prior art because it provides an efficient and practical approach for modeling motion in planar environments, which are common in robotics applications like factory floors or warehouses. Let W be half of the car width and let ρ be the wheel radius. Under the assumption of no lateral slip and single ground contact points for each wheel, the robot's motion is constrained by a non-holonomic constraint:

$${\underbrace{[ \begin{matrix}1 & 0 & W cos ( {θ}_{b} ) & - ρ cos ( {θ}_{b} ) & 0 \\ 0 & 1 & W sin ( {θ}_{b} ) & - ρ sin ( {θ}_{b} ) & 0 \\ 1 & 0 & - W cos ( {θ}_{b} ) & - ρ cos ( {θ}_{b} ) & 0\end{matrix} ]}}_{{Λ}_{b}} [ \begin{matrix}{q}_{b , 3} \\ {ν}_{w , r} \\ {ν}_{w , l}\end{matrix} ] = 0 ,$$

where v_{w,r} and v_{w,l} represents right and left wheel velocities. Rearranging this constraint, the kinematic model of the mobile base is given by:

$$\frac{d}{dt} {q}_{b , 3} = {\underbrace{[ \begin{matrix}\frac{ρ}{2} cos ( {θ}_{b} ) & \frac{ρ}{2} cos ( {θ}_{b} ) \\ \frac{ρ}{2} sin ( {θ}_{b} ) & \frac{ρ}{2} sin ( {θ}_{b} ) \\ \frac{ρ}{2 W} & - \frac{ρ}{2 W}\end{matrix} ]}}_{{J}_{w , 3}} [ \begin{matrix}{ν}_{w , r} \\ {ν}_{w , l}\end{matrix} ]$$

where J_{w,3} represents the Jacobian that maps wheel velocity to the 3-dimensional base velocity. As a result, the kinematic model of a mobile manipulator with a non-holonomic base can be summarized as:

$$\frac{d}{dt} [ \begin{matrix}{q}_{b , 3} \\ {q}_{a}\end{matrix} ] = [ \begin{matrix}{J}_{w , 3} ( {q}_{b , 3} ) & 0 \\ 0 & I\end{matrix} ] [ \begin{matrix}{ν}_{w} \\ {ν}_{a}\end{matrix} ] ,$$

where qₐ ∈Qⁿ^{ₐᵣₘ} and vₐ ∈ [symbol] ⁿ^{ₐᵣₘ} represent the position and velocity of the manipulator arm, v_{w}=[v_{w,r} v_{w,l}]^{T} and I is an identity matrix with appropriate dimension.

In some embodiments, the mobile base adopts different drive systems, e.g., front-wheel-drive, and the kinematic model of the mobile base admits the well-known bicycle model form.

In some embodiments, the mobile base adopts or omni-directional drive system, the kinematic model of the mobile base can also be readily found in the prior art.

The method for safe motion planning taught in this disclosure can be readily applied to mobile manipulators with different drive mechanisms.

### Description of Wheel-Ground Contact Model Assumption

Generally, a mobile manipulator experiences contact wrenches at all wheels that are in contact with the ground, where each wrench is a 6-dimension vector. The wheel-ground contact wrench, which encompasses normal forces, frictional forces and moments, and the resulting slip dynamics, is greatly influenced by factors such as slip angle, tire properties, surface material, and contact mechanics. While modeling individual contact wrenches at each wheel could theoretically offer added safety by capturing more granular wheel-ground interactions, modeling individual contact wrenches introduce considerable computational complexity and is unnecessary to derive a wheel-ground contact model of the mobile manipulator which captures the wrenches of all wheels and perform motion planning based on the model. The wheel-ground contact is simplified by treating the mobile base as a rigid body in contact with the ground. Since the main safety consideration is tip-over prevention, which is ensured by maintaining the ZMP remains within the support polygon on the ground. As a result, the wrenches exerted on all wheels are simplified as a single virtual lumped wrench given by

$$f = {[ \begin{matrix}{F}_{x} & {F}_{y} & {F}_{z} & {M}_{x} & {M}_{y} & {M}_{z}\end{matrix} ]}^{T} .$$

where Fₓ, F_{y}, F_{z} are the forces (that the ground applies on the rigid body) along the x, y, z axes, respectively, and Mₓ, M_{y}, M_{z} are the torques around the x, y, z axes, respectively. This simplification allows the reduction from full dynamics to centroidal momentum dynamics which is subject to the virtual lumped wrench and provide a practical balance that preserves critical safety aspects while significantly reducing computational demands.

### Reduced-Order Model

The reduced-order model 205 effectively captures the essential dynamics of robots for safety while maintaining computational efficiency. The reduced-order model 505 includes the following state variables:

$$x = [ \begin{matrix}{h}_{com} \\ q\end{matrix} ] = [ \begin{matrix}{h}_{com} \\ {q}_{b} \\ {q}_{w} \\ {q}_{a}\end{matrix} ] ∈ {ℝ}^{12 + {n}_{wheel} + {n}_{arm}}$$

where h_{com} ∈ [symbol] ⁶ is the centroidal momentum (including linear and angular momentums around the center of mass of the mobile manipulator), q_{b} ∈ [symbol] (3) represents the 6-dimensional configuration of the base, q_{w} represents the n_{wheel}-dimensional configuration of the actuated wheels, and qₐ denotes the nₐᵣₘ dimensional configuration of the manipulator. This allows the reduced order model to represent the dynamics associated with roll, pitch, and vertical motion, for stability analysis. By abstracting individual joint and link forces into a consolidated representation of the system's stability-related dynamics, the reduced order model 505 effectively filters out less impactful interactions while preserving accuracy in areas crucial for tip-over prevention and overall stability.

The centroidal momentum dynamics includes the external wrench f as its input, whereas the dynamics of q_{w} and qₐ have their velocities as inputs, respectively. Thus, the control inputs of the reduced order model are given by:

$$u = [ \begin{matrix}f \\ ν\end{matrix} ] = [ \begin{matrix}f \\ {ν}_{w} \\ {ν}_{a}\end{matrix} ] ∈ {ℝ}^{6 + {n}_{wheel} + {n}_{arm}} ,$$

where v represents the actuated joint velocities.

The equation of motion for the reduced-order model 505, incorporating non-holonomic constraints, is as follows:

$$\frac{d}{dt} x = \frac{d}{dt} [ \begin{matrix}{h}_{com} \\ {q}_{b} \\ {q}_{w} \\ {q}_{a}\end{matrix} ] = {\underbrace{[ \begin{matrix}{J}_{f} ( q ) & 0 & 0 \\ 0 & {J}_{w} ( {q}_{b} ) & 0 \\ 0 & I & 0 \\ 0 & 0 & I\end{matrix} ]}}_{A ( x )} u + {\underbrace{[ \begin{matrix}g \\ 0 \\ 0 \\ 0\end{matrix} ]}}_{b}$$

where J_{f}(q)∈ [symbol] ^{6×6} is the Jacobian relating the effect of the wrench to the derivative of the centroidal momentum, J_{w}(q_{b})∈ [symbol] ^{6×2} represents the non-holonomic constraints imposed by the wheel kinematics for 6-dimensional base definition, and g=[0 0 −g 0 0 0]^{T} is the gravitational force vector, where g=9.8 m/s². Note that J_{w}(q_{b}) includes zero entries for the roll, pitch, and vertical (z-axis) degrees of freedom, effectively extending the 3-dimensional wheel Jacobian J_{w,3} to a 6-dimensional configuration space. This extended formulation also assumes no wheel slippage and that tip-over is avoided. However, these assumptions are enforced through safety constraints, ensuring that the reduced order model's dynamics remain valid under these operating conditions.

The Jacobian J_{f}(q) for centroidal dynamics is defined as:

$${J}_{f} ( q ) = [ \begin{matrix}I & 0 \\ {[ {p}_{f} ( q ) - {p}_{com} ( q ) ]}_{\times } & I\end{matrix} ]$$

where p_{f}(q) and p_{com}(q) represent the location of contact force and CoM, respectively. The notation [.]ₓ denotes the transformation to a skew-symmetric matrix that models the cross product between the position and force vector.

An equality constraint is required to relate the robot's joint motions to its centroidal momentum, expressed as h_{com}=M(q)\dot{q}. The M(q) matrix is computed using centroidal composite rigid-body algorithm given the robot configuration. Since the velocity of the robot's base is underactuated and determined by the motion of the wheels under non-holonomic constraints, the centroidal momentum constraint is defined as follows:

$${h}_{com} = M ( q ) \dot{q} = {M}_{b} ( q ) {\dot{q}}_{b} + {M}_{w} ( q ) {\dot{q}}_{w} + {M}_{a} ( q ) {\dot{q}}_{a} = {M}_{b} ( q ) {J}_{w} ( {q}_{b} ) {ν}_{w} + {M}_{w} ( q ) {ν}_{w} + {M}_{a} ( q ) {ν}_{a} \text{=:} {M}_{hcom} ( q ) [ \begin{matrix}{ν}_{w} \\ {ν}_{a}\end{matrix} ] ,$$

where M_{hcom}(q) provides a compact representation of the centroidal momentum in terms of the reduced-order states x and inputs u. The centroidal momentum dynamics are subject to external forces and torques (wrenches) acting on the robot, with the momentum itself derived from the robot's joint positions and velocities. This relationship ensures that the model captures the impact of forces and moments at the center of mass, allowing for safe trajectory planning. The complete equation of motion i.e., reduced order model 505, incorporating the dynamics and non-holonomic constraints, is given by:

$$( \text{Reduced-order Model} )$$

$$\{ \begin{matrix}\frac{d}{dt} [ \begin{matrix}{h}_{com} \\ q\end{matrix} ] = A ( x ) u + b \\ {h}_{com} - {M}_{hcom} ( q ) ν = 0\end{matrix}$$

This coupled representation for dynamics ensures that the forces and moments applied through the control inputs are feasible through the robot's physical motion.

The single virtual lumped wrench model 500 is also used to model the safety constraints i.e., stability constraints applied on the external forces to determine safer trajectory of motion of the robot 300. Accordingly, the safe motion planner 405 input the wheel ground contact model 500 in the reduced order model 505 and modelling the stability constraints 510 to determine the safe trajectory of the movement of the robot as per the received waypoints.

### Stability Constraints

To ensure the safe and stable operation of the robot 300, the motion planner 405 imposes following safety constraints: ZMP constraints to prevent tip-over, friction constraints to avoid slipping, and joint limits to ensure physical feasibility.

The ZMP, denoted by p_{zmp}=[rₓ r_{y} 0]^{T}, represents the point on the ground plane where the resultant moment about horizontal axes is zero. To prevent tip-over, the ZMP has to remain within a support polygon defined by the wheel positions. In some embodiments, a rectangular support polygon with ZMP constraints is expressed as:

$$- α {l}_{a} \leq {r}_{x} \leq α {l}_{b} \\ - α {w}_{a} \leq {r}_{y} \leq α {w}_{b}$$

where lₐ, l_{b}, wₐ, w_{b} represent the distances to the edges of the support polygon from base frame location, and a is a tuning factor that adjusts the conservativeness of the constraints, allowing for compensation for dynamic uncertainty. In some embodiments, the support polygon is represented as a convex hull formed by the contact points of the wheels and thus the ZMP constraints on rₓ and r_{y} can be more general.

The location of the ZMP is determined by identifying the point at which applying force results in zero moments about the horizontal axes, which is defined by the following condition:

$${M}_{zmp}^{h} = [ \begin{matrix}{M}_{x} \\ {M}_{y}\end{matrix} ] + {( [ \begin{matrix}{r}_{x} \\ {r}_{y} \\ 0\end{matrix} ] \times [ \begin{matrix}{F}_{x} \\ {F}_{y} \\ {F}_{z}\end{matrix} ] )}_{x , y} = [ \begin{matrix}0 \\ 0\end{matrix} ] .$$

Solving this equation yields

$${r}_{x} = \frac{{M}_{y}}{{F}_{z}} and {r}_{y} = - \frac{{M}_{x}}{{F}_{z}} .$$

Substituting these expressions into the ZMP bounds, the constraints are reformulated in terms of the model inputs u as (C-ZMP):

$$( C - ZMP )$$

$$\{ \begin{matrix}- α {F}_{z} {l}_{a} \leq {M}_{y} \leq α {F}_{z} {l}_{b} , \\ - α {F}_{z} {w}_{a} \leq {M}_{x} \leq α {F}_{z} {w}_{b} .\end{matrix}$$

Further, to ensure stable contact between the wheels and the ground, the stability constraints 510 enforces a friction cone constraint that limits the allowable lateral forces:

$${F}_{x}^{2} + {F}_{y}^{2} \leq {μ}^{2} {F}_{z}^{2} ,$$

where μ is the friction coefficient. This constraint ensures that the lateral forces do not exceed what the ground friction can support, thereby preventing slipping. For computational simplicity, the friction cone, in some embodiments, is approximated by a friction pyramid with linear constraints as C-friction:

$$( \text{C-friction} )$$

$$\{ \begin{matrix}\vert {F}_{x} \vert \leq \frac{μ}{\sqrt{2}} {F}_{z} \\ \vert {F}_{y} \vert \leq \frac{μ}{\sqrt{2}} {F}_{z}\end{matrix} .$$

This approximation provides a conservative but computationally efficient alternative to the friction cone, allowing the friction limits be represented by using linear constraints.

In addition, the safety constraints model 510 imposes a constraint on the yaw moment to prevent excessive turning forces that, in some embodiments, cause slippage. Let v denote the rotational friction coefficient, the yaw moment constraint (C-rotation) is:

$$( \text{C-rotation} )$$

$$\vert {M}_{z} \vert \leq {vF}_{z} .$$

Together, these safety constraints model 510 ensure that the applied forces and moments remain within the limits of frictional stability, preventing both lateral and rotational slipping during maneuvers.

Further, to ensure that the planned trajectory respects the physical limitations of the robot's joints, in some embodiments, the safety constraints model 510 imposes inequality constraints (C-limit) on both joint positions and velocities:

$$\{ \begin{matrix}\underline{{q}_{a}} \leq {q}_{q} \leq \overline{{q}_{a}} , \\ \underline{{v}_{a}} \leq {v}_{a} \leq \overline{{v}_{a}} .\end{matrix} \qquad ( C - limit )$$

Here, qₐ and q̅ₐ̅ represent the lower and upper bounds on the joint positions, while vₐ and ≤v̅ₐ̅ define the velocity limits. These constraints ensure that joint movements remain within the robot's mechanical limits, preventing damage and ensuring safe operation.

Using the reduced order model 505 and the stability constraints provided by the model 510, the motion planner 405 generates the safe trajectory 520. For so doing, the safe motion planner 405 solves target-reaching tasks, formulated as an offline or online nonlinear program (NLP) to ensure safe and effective movement towards predefined goals.

To achieve safe motion planning, a nonlinear programming (NLP) problem is used that enables the generation of stable (safe) trajectories by solving for the state and control inputs across a preview horizon. For so doing, the planning horizon of t seconds id divided into N intervals with

$$dt = \frac{t}{N} .$$

At each time instance, the state and input is denoted by xᵢ ∇ᵢ∈[0, . . . , N] and uᵢ ∇ᵢ∈[0, . . . , N−1].

The objective function for the NLP formulation consists of two main terms: (1) an end-effector tracking term Jₑₑ, which drives the robot towards the target pose, and (2) a regularization term Jᵤ that minimizes control efforts and promote smooth and efficient movements.

The end-effector tracking cost Jₑₑ(xi) is formulated to minimize the difference between the current and target poses of the end-effector in the SE(3) space:

$${J}_{ee} ( {x}_{i} ) = {‖ e ( {q}_{i} ) ‖}_{{W}_{ee}} ,$$

where qᵢ is extracted from xi at each collocation node, and the notation

$${‖ X ‖}_{W}^{2} {=}^{Δ} {X}^{T} WX$$

defines a quadratic cost such that W is a positive-definite diagonal weight matrix. Additionally, a terminal cost J_{ee,N} (x_{N}) is defined with weight W_{ee,N} to ensure accurate tracking at the final time step. The pose error e(qᵢ) is calculated using twists from Lie algebra, which enables an efficient representation of the difference between the current and target poses in the SE(3) space:

$$e ( q ) := {T}_{s *} ⊖ {T}_{sb} ( q ) = {log}_{6} ( {T}_{bs} ( q ) {T}_{s *} ) = {log}_{6} ( {T}_{b *} ( q ) )$$

where T_{s*} represents the target end-effector pose in the world frame, T_{sb}(q) represents the pose of end-effector derived from forward dynamics of the robot in the world frame, and log₆:SE(3)→se(3) maps poses to twists. This twist-based error representation avoids issues like angle wraparound and ensures rotational errors are computed continuously without abrupt changes.

The input regularization cost on velocities and wrench is given as:

$${J}_{u} ( {u}_{i} ) = {‖ {f}_{i} ‖}_{{W}_{f}} + {‖ {v}_{w , i} ‖}_{{W}_{w}} + {‖ {v}_{a , i} ‖}_{{W}_{a}}$$

The complete optimization problem (NLP) is formulated as:

$${min}_{{x}_{0} … N , {u}_{0} … N - 1} {\sum }_{i = 1}^{N - 1} ( {J}_{ee} ( {x}_{i} ) + {J}_{u} ( {u}_{i} ) ) + {J}_{ee , N} ( {x}_{N} )$$

s. t. (Dynamics Constraints), (Safety Constraints).

Here, the (Dynamics Constraints) are enforced as equality constraints where the forward Euler scheme is used for collocation with equation of motion (Reduced-order Model). The Safety Constraints including (C-ZMP), (C-friction), (C-rotation) and (C-limit) are collectively represented as inequality constraints.

In this manner, the motion planner 405 generates the safe trajectory 520 for the movement of the robot to reach the object arranged at a predefined location. In some embodiments, the safe trajectory 520 is characterized by the temporal profile of the reduced-order model state x or equivalently the temporal profile of the reduced-order system/model control u over a time horizon.

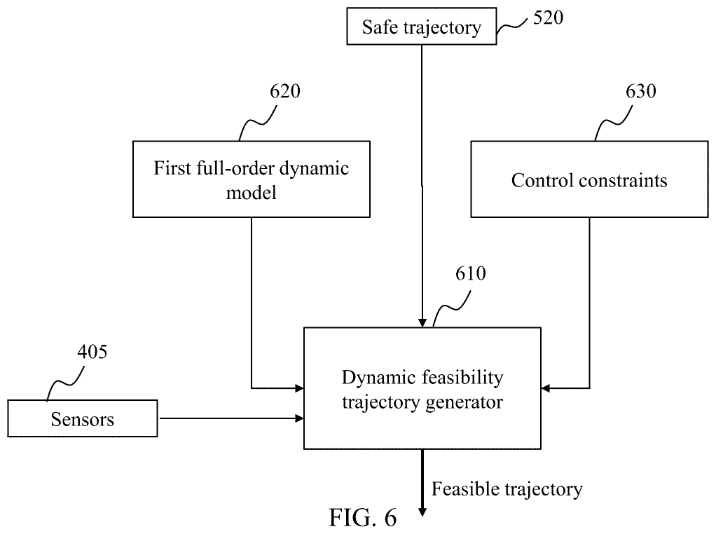

Referring to FIG. 6, a block diagram depicting various elements/features/steps involved in generating a feasible trajectory from the safe trajectory 520 is disclosed. As shown, a feasibility tracking generator 610 utilizes the safe trajectory 520 generated by the motion planner 405 and generates dynamically or check feasibility of the safe trajectory 520 at 610 by using a first full-order dynamic model 620 and control constraints 630. Also, the feasibility trajectory generator 610 uses input from the sensors 425 of the robot 300 to further determine the feasibility of the safe trajectory 520, and generates control command for controlling the robot 300 to move the robot based on the generated feasible trajectory.

In the embodiments, during generation of the feasible trajectory by the feasibility trajectory generator 610, the first full order dynamic model 620 accounts for dynamic feasibility of a maneuver of the robot according to safe trajectory 520, which involves dynamic mass inertia properties, and, in some embodiments, derived using rigid body dynamics. The first full-order dynamic model is given by

$$D ( q ) \ddot{q} + H ( q , \dot{q} ) = B τ + {Λ}^{T} λ , \qquad ( First Full - order Model )$$

$$Λ \ddot{q} + Λ \dot{q} = 0 ,$$

where

$$q = {[ \begin{matrix}{q}_{b , 3}^{T} & {q}_{w}^{T} & {q}_{a}^{T}\end{matrix} ]}^{T} .$$

D, H, B are the inertia matrix, the collection of centrifugal, Coriolis and gravitational forces, and the actuation matrix. The input torque is denoted by t and A represents the Lagrange multiplier that corresponds to the non-holonomic constraints where

$$Λ = [ \begin{matrix}{Λ}_{b} & {0}_{3 \times {n}_{arm}} ] .\end{matrix}$$

The use of a 3-dimensional base coordinate in dynamic models for robot 300 stems from the dynmics model's ability to capture the primary motion characteristics needed for planar movement tasks while maintaining computational simplicity. Since a 3D base model does not account for forces and torques along the vertical axis or rotations around the base's pitch and roll axes, the 3D base model cannot fully capture dynamics that are needed for tip-over prevention. In high-speed or high-load conditions, omitting vertical dynamics, in some embodiments, lead to inaccuracies in predicting stability. The use of the first full-order dynamic model 620 is not an issue for dynamic feasibility if it is preceded by the safe motion planner, because the safe trajectory 520 has been identified, and the dynamic feasible trajectory generator 610 finds a feasible trajectory as close to the safe trajectory 520 as possible-implying the safety of the feasible trajectory is likely preserved.

Given the safe trajectory 520 from the motion planner 405 and for generating the feasible trajectory, the feasibility tracking generator 610 defines output h(q,t) according to user's need. For example, h can be defined to minimize the tracking error for the end-effector pose such that

$$h ( q , t ) = {T}_{s *} ( t ) ⊖ {T}_{0 b} ( q )$$

The dynamic feasible trajectory generation and tracking controller 310 is realized by solving the following optimization problem:

$${min}_{\ddot{q} , τ , λ} {‖ \ddot{h} ( q , \dot{q} , \ddot{q} ) - {\ddot{h}}^{t} ‖}_{Q}^{2} , \qquad ( TSC - QP )$$

$$s . t . ( First Full - order Model ) \qquad ( Dynamics )$$

$${τ}_{lb} \leq τ \leq {τ}_{ub} . \qquad ( Torque Limit )$$

where \ddot{h}^{t}=−Kₚh−K_{d}\dot{h} is the target acceleration that enables exponential tracking, with Kₚ, K_{d} being the proportional and derivative gains. Tub and Tub are torque limits. Solving the optimization yields the optimal torque t for the robot.

The feasible trajectory generator 610 solves the optimization with a cost function which minimizes the error between the end-effector pose corresponding to the safe trajectory 520 and the end-effector pose corresponding to the feasible trajectory. This cost function is based on realization that the safety requirement has been captured by enforcing the closeness between the safe trajectory and feasible trajectory as much as possible while keeping the end-effector pose tracking accuracy.

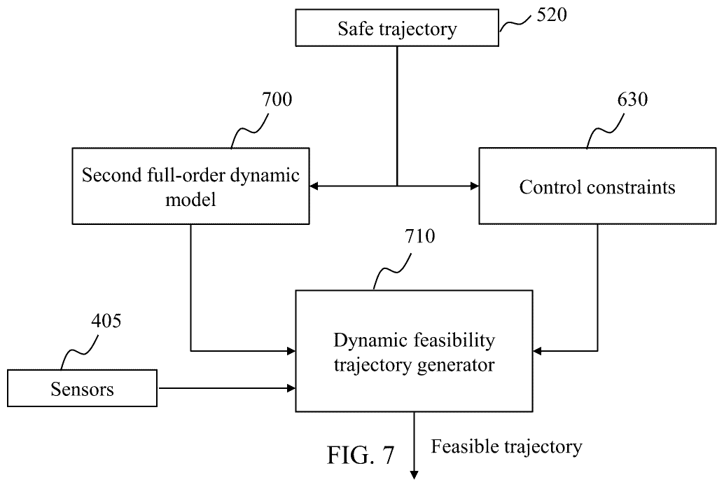

The feasibility trajectory generator 610 solves the dynamic feasible trajectory generation and tracking control problem without considering the safety constraints. Additionally, in some embodiments, if the dynamic model is expanded to take a 6-dimensional floating base q_{b} instead of q_{b,3}, additional safety constraints is to be applied. For considering the safety/stability constraints, a second full-order dynamic model 700 as described with reference to FIG. 7 is utilized.

Referring to FIG. 7, a block diagram depicting various elements/features of the controller 310 involved in generating the feasible trajectory is disclosed. As shown, a feasibility tracking generator 710 utilizes the safe trajectory 520 generated by the motion planner 405 and generates dynamically or check feasibility of safe trajectory 520 by using second full-order dynamic model 700 and control constraints 630. Also, the feasibility trajectory generator 710 uses input from the sensors 425 of the robot 300 to further determine the feasibility of the safe trajectory 520, and generates control command for controlling the robot 300 to move the robot based on the generated feasible trajectory.

Second full-order dynamic model 700 is an expansion of the first full-order dynamic model 620 to take a 6-dimensional floating base q_{b} instead of q_{b,3} in which the safety/stability constraints are applied as follows:

$$D ( q ) \ddot{q} + H ( q , \dot{q} ) = B τ + {Λ}^{T} λ + {J}^{T} {f}_{c} , \qquad ( Second Full - order Model )$$

$$Λ \ddot{q} + \dot{Λ} \dot{q} = 0 ,$$

$$J \ddot{q} + \dot{J} \dot{q} = 0$$

where

$$q = {[ \begin{matrix}{q}_{b}^{T} & {q}_{w}^{T} & {q}_{a}^{T}\end{matrix} ]}^{T} .$$

D, H, B and A are again the inertia matrix, the collection of centrifugal, Coriolis and gravitational forces, the actuation matrix and non-holonomic constraint matrix. The Lagrange multiplier for the non-holonomic constraint does not correspond to physical force, but Lagrange multiplier does constrain the motion of the corresponding degree of freedom and relates base x, y, and yaw accelerations to wheel accelerations. The matrix J is the jacobian of the holonomic constraint that ensures the base z position, roll, and pitch angle is stationary, which corresponds to the physical force and moment given by f_{c}=[F_{z} Mₓ M_{y}]^{T}. f_{c} can then be used to enforce safety constraints.

Now, to generate the feasible trajector, a feasibility trajectory generator 710 applies the second full-order dynamic model 700 on the safe trajectory 520 and the control constraints 630 along with inputs from the sensors 425 to generate the feasible trajector and generates control commands to control the robot 300. The feasibility trajectory generator 710 generating the feasible trajectory by solving the following optimization problem:

$${min}_{\ddot{q} , τ , λ} {‖ \ddot{h} ( q , \dot{q} , \ddot{q} ) - {\ddot{h}}^{t} ‖}_{Q}^{2} , \qquad ( TSC - QP2 )$$

$$s . t . ( Second Full - order Model ) \qquad ( Dynamics )$$

$$( C - ZMP ) \qquad ( ZMP constraint )$$

$${τ}_{lb} \leq τ \leq {τ}_{ub} . \qquad ( Torque Limit )$$

Compared to (TSC-QP), this optimization is similarly a quadratic program that solves for optimal actuation torque for exponential tracking of the desired output. Using the second full-order dynamic model 700, additional safety criteria that ensure ZMP is within the support polygon of the base are imposed.

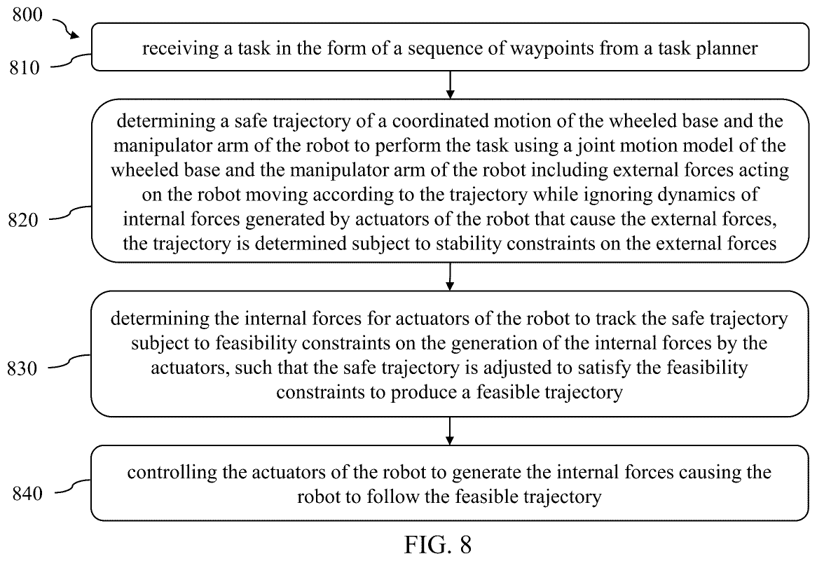

Referring to FIG. 8, a method 800 for controlling the robot 300 to perform a task is shown. The method 800 uses a processor to carry out the steps/instructions of the method stored in a memory. The method 800 includes a step 810 of receiving the task in the form of a sequence of waypoints from a task planner, for example, the task planner 400 of the controller 310. The sequence of waypoint are determined by the task planner such that the robot 300 is collision-free at the sequence of waypoints. Thereafter, the method 800 includes a step 820 of determining a safe trajectory of a coordinated motion of the wheel base 302 of the robot 300 and the manipulator arm 304 of the robot 100 to perform the task using a joint motion model of the wheeled base 302 and the manipulator arm 304 of the robot 300. In some embodiments, the joint motion model is implemented as the reduced-order model 505 that simplifies stability assessment by aggregating external force effects into a compact representation, reducing computational complexity while preserving safety guarantees.

In embodiments, the joint motion model generates the safe trajectory based on external forces acting on the robot 300 moving according to the safe trajectory while ignoring dynamics of internal forces generated by actuators of the robot 300 that cause the external forces. In the embodiment, the safe trajectory is determined subject to stability constraints on the external forces ensuring that external forces maintain dynamic stability of the robot. In some embodiments, the stability constraints includes one or more of ZMP constraints, friction constraints, rotation constraint, and joint angle constraints. The external forces include ground reaction forces, gravitational forces, inertial forces, etc. Also, in some embodiments, the motion planner 405 dynamically adapts the stability constraints based on variations in external forces, including changes in payload weight, ground reaction forces, or acceleration-induced inertial loads, to ensure continuous stability of the robot during motion. In the embodiments, the joint motion model i.e., reduced order model includes a centroidal momentum model that represents the dynamics of the net linear and angular momentum of the robot's center of mass, thereby enabling the determination of external forces result from a motion while ignoring joint-level internal forces.

Upon determining the safe trajectory, the method 800 includes a step 830 of determining the internal forces for the actuators of the robot 300 to track or follow the safe trajectory subject to feasibility constraints on the generation of the internal forces by the actuators. In some embodiments, the feasibility constraints on the internal forces include actuator torque limits, velocity constraints, and power consumption constraints. In embodiments, the processor adjusts the safe trajectory to satisfy the feasibility constraints to produce a feasible trajectory when infeasibility of tracking or follow the safe trajectory is detected. In some embodiments, the adjustment of the safe trajectory includes modifying at least one of the manipulator arm's motion, wheeled base velocity, or acceleration to ensure compliance with the feasibility constraints. In some embodiments, the safe trajectory is adjusted in real time i.e., during the motion of the robot. In some embodiments, the real time adjustment to the safe trajectory is performed by prioritizing maintaining stability constraints over achieving exact safe trajectory tracking by the robot.

The method 800 also includes a step 840 of controlling the actuators of the robot 300 to generate the internal forces causing the robot to follow the feasible trajectory or the safe trajectory to perform the task. In this manner, the method 800 facilitates in controlling the robot in performing the task in an efficient and fast manner while ensuring the stability of the robot while performing the task.

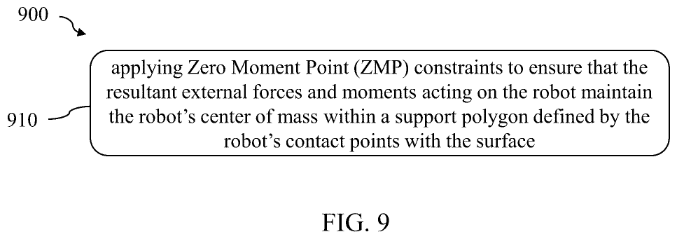

Referring to FIG. 9, a method 900 for enforcing the stability constraints on the external forces is shown. The method 900 includes a step 910 of applying Zero Moment Point (ZMP) constraints on the external forces to ensure that the resultant external forces and moments acting on the robot maintain the robot's center of mass within a support polygon defined by the robot's contact points with the surface. As the ZMP remains with the support polygon, the tipping of the robot during the motion of the robot 300 i.e., combined movement of the wheeled base 302 and the manipulator arm 304 is prevented. In some embodiments, the stability constraints additionally characterizes whether external forces are possible to be generated through the dynamic interactions between the wheels and ground. In some embodiments, the method 900 includes applying additional stability constraints, for example, one or more of friction constraints, rotation constraint, and joint angle constraints, to prevent tipping of the robot 300.

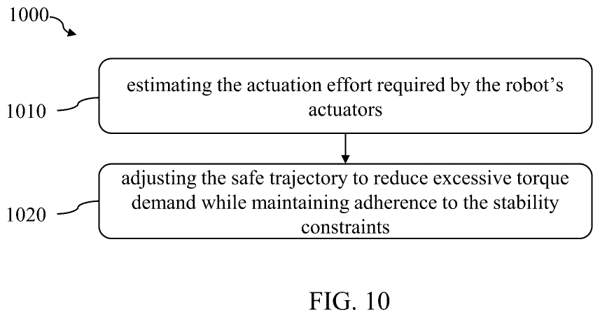

Referring to FIG. 10, a method 1000 for determining internal forces for tracking/following the safe trajectory and adjusting the safe trajectory to the feasible trajectory is shown. The method 1000 includes a step 1010 of estimating the actuation effort required by the robot's motors/actuators to follow/track the safe trajectory. Upon estimating the actuation effort, the method 1000 at a step 1020 adjusts the trajectory to reduce excessive torque demand while maintaining adherence to the stability constraints. The torque on the actuators are reduced such that the torque remains within the torque limits of the associated actuator.

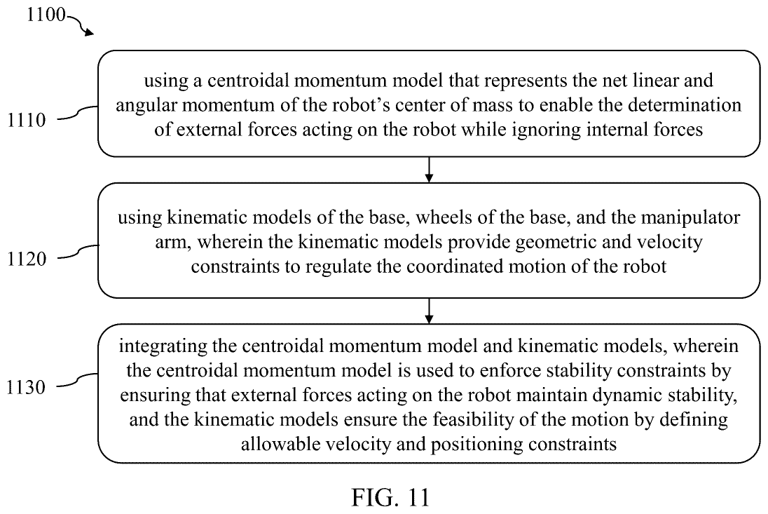

Referring to FIG. 11, a method 1100 for determining the safe trajectory by using a joint motion model is shown. The method 1100 includes a step 1110 of using a centroidal momentum model that represents the net linear and angular momentum of the robot's center of mass to enable the determination of external forces acting on the robot while ignoring internal forces. Further, in some embodiments, the centroidal momentum model incorporates external force estimation from sensor feedback, including ground reaction forces and payload effects, to enhance real-time trajectory adjustments.

The method 1100 also includes a step 1120 of using kinematic models of the base, wheels of the base, and the manipulator arm, wherein the kinematic models provide geometric and velocity constraints to regulate the coordinated motion of the robot. In some embodiments, the kinematic model of the wheeled base 302 includes a nonholonomic motion constraint derived from the wheel-ground contact dynamics to ensure that the generated safe trajectory adheres to the feasible motion constraints of the wheeled base. Also, in some embodiments, the kinematic model of the manipulator arm 304 is used to regulate the position and velocity of the end effector 306 of the robot 300 for ensuring that the manipulator arm's motion without violating the stability constraints imposed by the centroidal momentum model.

The method 1100 further includes a step 1130 of integrating the centroidal momentum model and kinematic models, wherein the centroidal momentum model is used to enforce stability constraints by ensuring that external forces acting on the robot maintain dynamic stability. For so doing, in some embodiments, centroidal momentum model computes Zero Moment Point (ZMP) constraints in real-time, ensuring that the resultant external forces and moments acting on the robot maintain the center of mass within a predefined support polygon. In some embodiments, the centroidal momentum model and the kinematic models are used together in an optimization-based motion planning process that balances the stability constraints imposed by external forces with the motion feasibility constraints of the robot. In some embodiments, the method further includes computing an adaptive trade-off between wheeled base velocity and manipulator extension to dynamically optimize stability and task efficiency to achieve speed while maintaining stability.

1. A method for controlling a robot for performing a task, wherein the robot is a mobile manipulator including a nonholonomic base having wheels for moving on flat surfaces and a manipulator arm connected to the wheeled base and having degrees of freedom for performing the task, wherein the method comprises performing the following steps using a processor coupled with stored instructions:
receiving a task in the form of a sequence of waypoints from a task planner, wherein the mobile manipulator, if located at the sequence of waypoints, is collision-free;
determining a safe trajectory of a coordinated motion of the wheeled base and the manipulator arm of the robot to perform the task using a joint motion model of the wheeled base and the manipulator arm of the robot including external forces acting on the robot when the robot moves according to the safe trajectory while ignoring dynamics of internal forces generated by actuators of the robot that cause the external forces, wherein determining the safe trajectory further comprises applying stability constraints on the external forces ensuring that external forces maintain dynamic stability of the robot;
determining the internal forces for actuators of the robot to track the safe trajectory subject to feasibility constraints on the generation of the internal forces by the actuators, such that the safe trajectory is adjusted to satisfy the feasibility constraints to produce feasible trajectory;
generating a feasible trajectory by adjusting the safe trajectory to satisfy feasibility constraints, wherein adjusting the safe trajectory comprises determining internal forces to be generated by the actuators of the robot when following the safe trajectory which satisfy the feasibility constraints; and
controlling the actuators of the robot to generate the internal forces to be generated by the actuators of the robot causing the robot to follow the feasible trajectory.

2. The method of claim 1 wherein the waypoints represents a pose of an end-effector or configurations of the manipulator arm and the wheeled base.

3. The method of claim 1, wherein the method further comprises:
enforcing stability constraints on the external forces are enforced by applying Zero Moment Point (ZMP) constraints to ensure that the resultant external forces and moments acting on the robot maintain a ZMP of the robot within a support polygon defined by contact points of the robot with the surface.

4. The method of claim 1, wherein the stability constraints comprise Zero Moment Point (ZMP) constraints, friction constraints, a rotation constraint, and joint angle constraints.

5. The method of claim 1, wherein the joint motion model includes a centroidal momentum model that represents a dynamics of a net linear and angular momentum of the robot's center of mass, thereby enabling a determination of external forces resulting from a motion while ignoring joint-level internal forces.

6. The method of claim 1, wherein the method further comprises:
subjecting the joint motion model to a virtual lumped wrench which characterizes an interaction between the wheels and a ground.

7. The method of claim 1, wherein the feasibility constraints include actuator torque limits, velocity constraints, and power consumption constraints, and wherein adjusting the safe trajectory comprises modifying at least one of the manipulator's motion, base velocity, or acceleration to ensure compliance with the feasibility constraints.

8. The method of claim 1, wherein determining the internal forces to be generated includes estimating an actuation effort required by the robot's actuators.

9. The method of claim 1, wherein adjusting the safe trajectory comprises using an optimization-based real-time trajectory modification prioritizing maintaining stability constraints over achieving trajectory tracking.

10. The method of claim 1, wherein determining the safe trajectory further comprises considering a dynamic trade-off between manipulator extension and base velocity, wherein the method further comprises adjusting a position of the manipulator arm to maintain stability constraints while allowing for increased movement efficiency.

11. The method of claim 1, wherein the method further comprises:
dynamically adapting stability constraints based on variations in external forces, including changes in payload weight, ground reaction forces, or acceleration-induced inertial loads, to ensure continuous stability of the robot.

12. The method of claim 1, wherein the joint motion model is implemented as a reduced-order model simplifying stability assessment by aggregating external force effects into a compact representation.

13. The method of claim 1, wherein determining the safe trajectory by using the joint motion model comprises:
using a centroidal momentum model representing a net linear and angular momentum of the center of mass of the robot;
using kinematic models of the base, wheels of the base, and the manipulator arm, and integrating a centroidal momentum model and the kinematic models, wherein the kinematic models comprise geometric and velocity constraints regulating the coordinated motion of the wheeled base and the manipulator arm of the robot; and
ensuring that external forces acting on the robot maintain dynamic stability by enforcing stability constraints by using the centroidal momentum model; wherein the kinematic models define allowable velocity and positioning constraints.

14. The method of claim 13, further comprising:
computing Zero Moment Point (ZMP) constraints in real-time, ensuring that the resultant external forces and moments acting on the robot maintain the center of mass within a predefined support polygon.

15. The method of claim 13, wherein the kinematic model of the wheeled base includes a nonholonomic motion constraint derived from the wheel-ground contact dynamics, ensuring that the generated feasible trajectory adheres to the feasible motion constraints of the base.

16. The method of claim 13, wherein the method further comprises:
regulating a position and velocity of an end effector of the robot using the kinematic model of the manipulator arm.

17. The method of claim 13, wherein the method further comprises:
balancing stability constraints imposed by external forces with motion feasibility constraints of the robot with an optimization-based motion planning process using the centroidal momentum model and the kinematic models together.

18. The method of claim 13, wherein the method further comprises:
dynamically optimizing stability and task efficiency by computing an adaptive trade-off between base velocity and manipulator extension.

19. The method of claim 13, wherein the method further comprises:
enhancing real-time trajectory adjustments by incorporating external force estimation from sensor feedback, including ground reaction forces and payload effects into the centroidal momentum model.
